(19) United States
(12) Patent Application Publication
(10) Pub. No.: US 2002/0093210 A1
(43) Pub. Date: Jul. 18, 2002

(54) Tip for tool heads

(76) Inventors: Richard L. Sassone, Elk Grove Village, IL (US); Joseph A. Veltri, East Dundee, IL (US); Norman J. Hendle, Roselle, IL (US)

Correspondence Address: Randy J. Pritzker, c/o Wolf, Greenfield & Sacks, P.C., Federal Reserve Plaza, 600 Atlantic Avenue, Boston, MA, 02210-2211, US

(21) Appl. No.: 09/760,023

(22) Filed: Jan. 12, 2001

(51) Int. Cl. A47J 43/28

(52) U.S. Cl. 294/7

(57) ABSTRACT

The present invention is directed to a tip for a tool head of a kitchen utensil. The tip provides a protective edge to prevent the kitchen utensil from scratching the non-stick coating on pots and pans. The tip is preferably made of a high temperature nylon material and is injection molded onto at least a portion of the edge of the tool head. The tip can be made in a variety of thicknesses, but is preferably substantially the same thickness as the tool head to provide a smooth transition from the tool head to the tip. The tip may cover a portion of the edge of the tool head or the whole exposed edge of the tool head. The tip may be placed on a variety of different tool heads known to those of ordinary skill in the art of kitchen utensils including spatulas and spoons.

### FIELD OF THE INVENTION

This application relates to kitchen utensils. More specifically, this application relates to a special tip for tool heads of kitchen utensils.

### BACKGROUND OF THE INVENTION

Non-stick pots and pans are popular kitchen cookware items. The pots and pans have a non-stick coating applied to their cooking surface to prevent foods from sticking to the pot or pan during cooking. Typically, the coating is a tough, insoluble polymer such as polytetrafluorethylene (PTFE) or Teflon. Conventional cooking utensils used to prepare food in pots and pans, such as spoons, spatulas and other kitchen utensils, are generally made of metal such as stainless steel. The metal cooking utensils can scratch, scrape or mar the non-stick coating on the pots and pans during cooking. This damage to the coating can result in the pot or pan no longer having a working non-stick surface. Thus, the outcome is often the need to purchase a new pot or pan.

U.S. Pat. No. 5,176,418 discloses a kitchen spatula having a protective jacket that is heat resistant, and has round protruded hooks and an insertion portion. The kitchen spatula has parallel grooves, some which are provided with expansion holes that correspond to the protruded hooks on the protective jacket. The protruded hooks are put through the corresponding expansion holes and are slid into the grooves of the spatula, and the insertion portion of the protective jacket retains the front edge of the spatula. The protective jacket is removable. Food can get caught in the protective jacket during cooking. Specifically, food can get caught between the spatula and the protective jacket, especially in the grooves of the spatula and the protruded hooks of the protective jacket. Thus, the kitchen spatula may be harder to clean and may need to be disassembled for proper cleaning.

### SUMMARY OF THE INVENTION

Applicants discovered that it is desirable to have a kitchen utensil having a tool head with a tip that can be used on non-stick pots and pans where food is less likely to get caught in the utensil during cooking. The present invention is directed to a tip for a tool head of a kitchen utensil. The tip of the present invention assists in preventing the kitchen utensil from scratching, scraping or marring the non-stick coating on the cooking surface of pots and pans. The tip is preferably provided on the edge of the tool head that comes into contact with the pot or pan. The tip is molded onto the edge of the tool head making it less likely to catch food during cooking and more likely easier to clean.

The tip is provided on at least a portion of an edge of the tool head. The tip is preferably insert molded onto at least a portion of the edge of the tool head using an injection molding process. In the preferred embodiment, the tip is made of a high temperature nylon material, although any suitable material may be used. The tip can be made in a variety of thicknesses, but is preferably substantially the same thickness as the tool head thereby providing a smooth transition from the tool head to the tip. The tip may cover a portion of the edge of the tool head, such as the portion that will come into contact with the non-stick surface of the pot or pan. Alternatively, substantially the entire exposed edge of the tool head may be provided with the tip. In the preferred embodiment, the edge of the tool head to be covered with the tip is provided with a recessed extending lip and the tip is molded over the recessed extending lip.

The tip may be placed on a variety of different tool heads known to those of ordinary skill in the art of kitchen utensils, including spatulas and spoons. The tool head may be made of a variety of different materials and metals. Preferably, the tool head is made of stainless steel. Moreover, any desired handle and method of attaching the handle to the tool head known to those of ordinary skill in the art may be used with the present invention.

### BRIEF DESCRIPTION OF THE DRAWINGS

Other features and advantages of the invention will become apparent from the following detailed description taken in conjunction with the accompanying drawings, in which:

FIG. 1A is a top view of an embodiment of a kitchen utensil made according to the present invention;

FIG. 1B is a side view of the kitchen utensil of FIG. 1;

FIG. 1C is a top view of the tool head of the kitchen utensil of FIG. 1;

FIG. 1D is a cross-sectional view taken along line 1D-1D in FIG. 1C;

FIG. 2A is a top view of another embodiment of a kitchen utensil made according to the present invention;

FIG. 2B is a side view of the kitchen utensil of FIG. 2A;

FIG. 2C is a top view of the tool head of the kitchen utensil of FIG. 2A; and

FIG. 2D is a cross-sectional view taken along line 2D-2D in FIG. 2C.

### DETAILED DESCRIPTION

The present invention relates to a tip for kitchen utensils and a utensil head including a tip molded thereto. The kitchen utensil of the present invention is illustrated as a spatula and spoon having the subject invention. However, the tip of the subject invention may be applied to the full spectrum of kitchen tools and utensils such as turners and many other kitchen utensils. The tip may also be provided on tool heads for use outside of the kitchen.

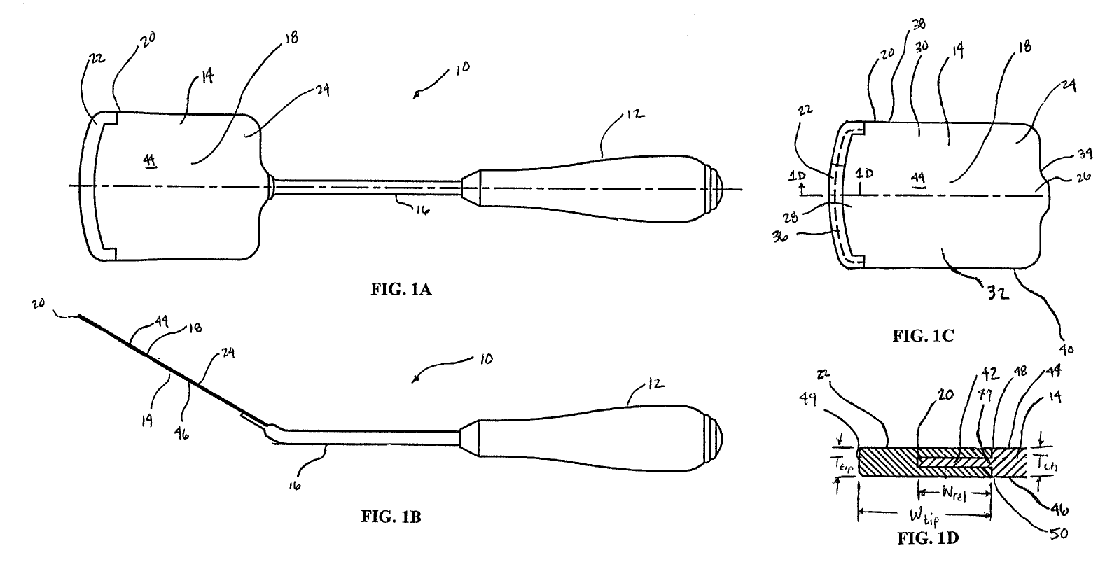

As best seen in FIGS. 1A-B and 2A-B, the kitchen utensil 10 is provided with a handle 12 and a work end or tool head 14. The handle 12 provided on the kitchen utensil 10 may be any handle known to those of ordinary skill in the art, and may be attached to the tool head in any manner known to those of ordinary skill in the art. For example, the kitchen utensil handle may be made of wood or plastic and adhesively secured to a stainless steel stalk 16 that is welded to the tool head. Preferably, the stalk 16 is centrally aligned with the tool head 14. Thus, the handle and the stalk shown in the Figures are provided for illustrative purposes only. The tool head has a body 18 with an edge 20. The edge 20 is molded with a tip 22.

In one embodiment, the tool head 14, seen in FIGS. 1A-C, is configured as a spatula 24. The spatula is substantially flat and rectangular shaped with a stalk end 26 for attachment to a handle 12, a free end 28 opposite the stalk end, and two side ends 30 and 32 connecting the stalk end and the free end. Each stalk end, free end and side end has a respective outside edge 34, 36, 38, and 40. At least a portion of one outside edge is provided with a tip 22 that is injection molded onto the tool head. As shown in the embodiment of FIGS. 1A-C, the tip is provided on the edge 36 of the free end 28 and on portions of the edges 38 and 40 of the side ends 30 and 32 adjacent to the free end, as these edges are most likely to come into contact with the cooking surface of a cookware item such as a pot or pan. Any portion of each edge 34, 36, 38 and 40 may be provided with the tip, including the entire edge 20 of the spatula.

As shown in FIG. 1D, illustrating a cross-sectional view of the preferred tip 22 of the invention, the edge 20 of the spatula that includes the tip preferably has a recessed lip 42. The spatula has top and bottom surfaces 44 and 46 (see FIGS. 1A-B) and the edge of the spatula has a top portion 48 and a bottom portion 50. In one embodiment, each of the top portion 48 and bottom portion 50 of the edge 20 to be covered with the tip is recessed from the respective top and bottom surfaces 44 and 46 of the spatula to form a recessed extending lip 42. Alternatively, the recessed extending lip could be provided on one of the top and bottom portions of the edge. As shown in FIG. 1D, the tip preferably has a thickness Tₜᵢₚ substantially corresponding to the thickness Tₜₕ of the spatula to provide a smooth transition along an outer surface from the spatula to the tip, although the tip may be any desired thickness. The tip may have substantially the same thickness as the tool head at a transition portion 47 and then taper to an outside edge 49 of the tip. The tip may be any desired width Wₜᵢₚ, but preferably extends about 3 to 7 mm. Preferably, the recessed extending lip has a width Wᵣₑₗ of about 2 to 4 mm, such that the tip covers and extends beyond the recessed lip.

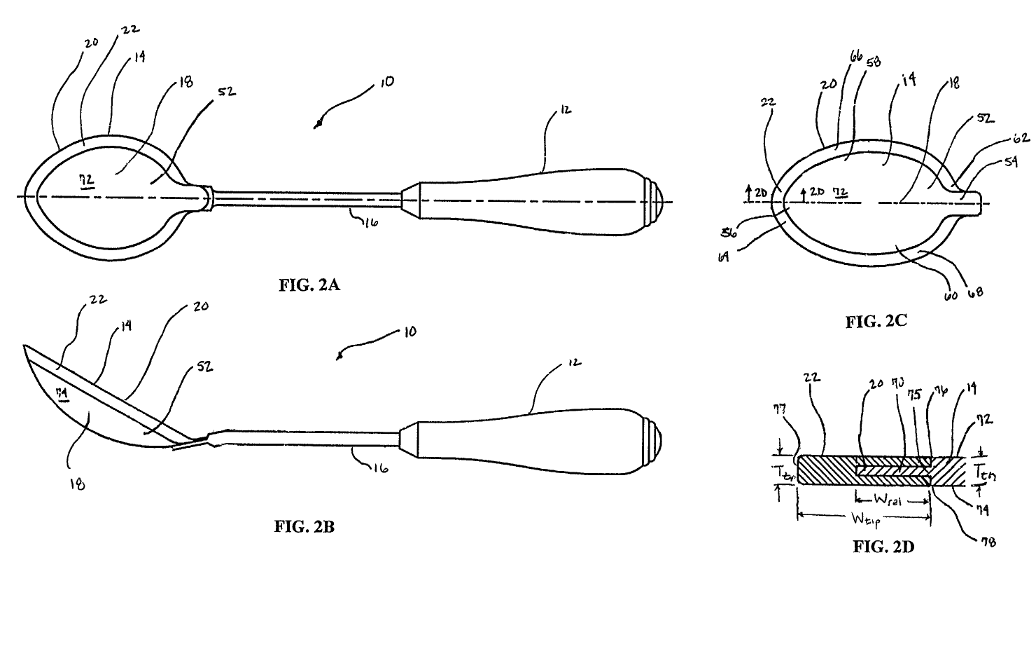

In the alternative embodiment, the tool head 14, seen in FIGS. 2A-C, is configured as a spoon 52. The spoon is substantially oval and bowl shaped with a curved stalk end 54 for attachment to a handle, a curved free end 56 opposite the curved stalk end, and two curved side ends 58 and 60 connecting the stalk end and the free end. Each stalk end, free end and side ends has a respective outside edge 62, 64, 66 and 68. At least a portion of one outside edge has a tip 22 that is injection molded onto the tool head. As shown in the preferred embodiment of FIGS. 2A-C, the tip is provided on the edge 64 of the free end 56, the edges 66 and 68 of the side ends 58 and 60 and on portions of the edge 62 of the stalk end 54 adjacent to the side ends. Any portion of each edge 62, 64, 66 and 68 may be provided with the tip, including the entire edge 20 of the spoon or only a portion of the edge 20 of the spoon.

As shown in FIG. 2D, the edge 20 of the spoon 52 that includes the tip 22 preferably has a recessed lip 70. The spoon has top and bottom surfaces 72 and 74 (see FIGS. 2A-B) and the edge 20 of the spoon has a top portion 76 and a bottom portion 78. Preferably, each of the top portion 76 and bottom portion 78 of the edge to be covered with the tip is recessed from respective top and bottom surfaces 72 and 74 of the spoon to form a recessed extending lip 70. Alternatively, the recessed extending lip could be provided on one of the top and bottom portions of the edge. As shown in FIG. 2D, the tip preferably has a thickness Tₜᵢₚ substantially corresponding to the thickness of the spoon Tₜₕ to provide a smooth transition along an outer surface from the spoon to the tip, although the tip may be any desired thickness. The tip may have substantially the same thickness as the tool head at a transition portion 75 and then taper to an outside edge 77 of the tip. The tip may be any desired width Wₜᵢₚ, but preferably extends about 3 to 7 mm. Preferably, the recessed extending lip has a width Wᵣₑₗ of about 2 to 4 mm, such that the tip covers and extends beyond the recessed lip.

The tip is formed by injection molding the tip onto the desired portion of the edge of the tool head. For example, a mold is made to accommodate the tool head and allow the formation of the tip around the desired portion of the edge of the tool head. The material used to form the tip is then heated in a barrel or hopper until the material is a consistency capable of being injected into the mold. The tool head is placed within the mold and the heated material is injected into the mold, and flows into the mold to form the contoured tip around the desired edge of the tool head. The mold is then allowed to cool so that the material solidifies. The tool head with the tip molded on the edge is then removed from the mold and may be attached to any desired handle by any method known to those of ordinary skill in the art.

Preferably, the tip is formed of a high temperature nylon such as nylon 6/6, or an equivalent that can withstand heat of 400-425° F., although any suitable material may be used to form the tip. The tool head is preferably made of any metal such as stainless steel, chrome-plated steel, cold roll steel and powder-coated steel, but can be made of any other suitable material or metal.

Although the present invention is described with reference to certain preferred embodiments, it will be appreciated that numerous modifications and other embodiments may be devised by those skilled in the art. For example, the recessed lip may be formed having a varying width such that the outside edge of the recessed lip is jagged. Therefore, it will be understood that the appended claims are intended to cover all such modifications and embodiments which come within the spirit and scope of the present invention.

What is claimed is:

1. A tool head comprising:
a body having an outer edge; and
a tip provided on at least a portion of the edge of the body,
wherein the tip is injection molded onto the edge of the body.

2. The tool head as recited in claim 1, wherein the tip is molded on substantially the entire edge of the body.

3. The tool head as recited in claim 1, further comprising:
a recessed lip provided on at least a portion of the edge of the body,
wherein the tip is molded on the recessed lip.

4. The tool head as recited in claim 3, further comprising;
a top portion of the edge of the body; and
a bottom portion of the edge of the body,
wherein the recessed lip is provided on one of the top and bottom portions of the edge.

5. The tool head as recited in claim 4, wherein:
the recessed lip is provided on both the top and bottom portions of the edge of the body, and the tip is molded on the recessed lip.

6. The tool head as recited in claim 1, wherein the tool head has a thickness substantially the same as a thickness of the tip.

7. The tool head as recited in claim 1, wherein the tip is made at least in part from high temperature nylon.

8. The tool head as recited in claim 1, wherein the tool head is made at least in part from stainless steel.

9. The tool head as recited in claim 1, wherein the tool head is a spatula.

10. The tool head as recited in claim 1, wherein the tool head is a spoon.

11. A kitchen utensil comprising:
a handle;
a tool head having an edge substantially surrounding the tool head, the tool head being joined to the handle; and
a tip provided on at least a portion of the edge of the tool head disposed away from where the tool head is joined to the handle,
wherein the tip is injection molded onto the edge of the tool head.

12. The kitchen utensil as recited in claim 11, wherein the tip is molded on substantially the entire edge of the tool head.

13. The kitchen utensil as recited in claim 11, further comprising:
a recessed lip provided on at least a portion of the edge of the tool head,
wherein the tip is molded on the recessed lip.

14. The kitchen utensil as recited in claim 13, further comprising;
a top portion of the edge of the tool head; and
a bottom portion of the edge of the tool head,
wherein the recessed lip is provided on one of the top and bottom portions of the edge.

15. The kitchen utensil as recited in claim 14, wherein:
the recessed lip is provided on both the top and bottom portions of the edge of the tool head, and the tip is molded on the recessed lip.

16. The kitchen utensil as recited in claim 11, wherein the tool head has a thickness substantially the same as a thickness of the tip.

17. The kitchen utensil as recited in claim 11, wherein the tip is made at least in part from high temperature nylon.

18. The kitchen utensil as recited in claim 11, wherein the tool head is made at least in part from stainless steel.

19. The kitchen utensil as recited in claim 11, wherein the tool head is a spatula.

20. The kitchen utensil as recited in claim 11, wherein the tool head is a spoon.

21. The kitchen utensil as recited in claim 11, further including:
a stalk having a first end and a second end, the first end being connected to the handle and the second end being connected to the tool head.

22. The kitchen utensil as recited in claim 21, wherein the stalk is connected to the tool head opposite from the portion of the edge provided with the tip.

23. A method of making a tip for a tool head comprising the steps of:
providing a mold;
placing a tool head into the mold, the tool head having an edge with a top portion and a bottom portion;
injection molding material into the mold to form a tip around at least a portion of the edge of the tool head.

24. The method as recited in claim 23, further comprising the step of:
heating the material such that it becomes a consistency capable of being injected into the mold.

25. The method as recited in claim 23, further comprising the step of:
cooling the material in the mold such that the material forming the tip on the edge of the tool head solidifies.

26. The method as recited in claim 23, the step of molding further comprising: molding the tip on substantially the entire edge of the tool head.

27. The method as recited in claim 23, wherein:
the edge of the tool head further comprises a recessed lip provided on at least a portion of the edge of the tool head, and the step of molding further comprises molding the tip on the recessed lip.

28. The method as recited in claim 27, further comprising the steps of:
providing the recessed lip on one of the top and bottom portions of the edge of the tool head, and molding the tip on the recessed lip of the edge of the tool head.

29. The method as recited in claim 27, further comprising the steps of:
providing the recessed lip on both the top and bottom portions of the edge of the tool head, and molding the tip on the recessed lip of the edge of the tool head.

30. The method as recited in claim 23, wherein the tool head has a thickness substantially the same as a thickness of the tip.

31. The method as recited in claim 23, wherein the tip is made at least in part from high temperature nylon.

32. The method as recited in claim 23, wherein the tool head is made at least in part from stainless steel.

33. The method as recited in claim 23, wherein the tool head is a spatula.

34. The method as recited in claim 23, wherein the tool head is a spoon.

35. The method as recited in claim 23, further comprising the step of:
providing a stalk having a first end and a second end, wherein the first end is connected to a handle and the second end is connected to the tool head.

36. The method as recited in claim 35, wherein the stalk is connected to the tool head opposite from the portion of the edge molded with the tip.
